(19) United States
(12) Patent Application Publication
(10) Pub. No.: US 2017/0319008 A1
(43) Pub. Date: Nov. 9, 2017

(54) TOASTER ATTACHMENT

(71) Applicant: Gyan Prakash KESARWANI, DELHI (IN)

(72) Inventor: Gyan Prakash KESARWANI, DELHI (IN)

(21) Appl. No.: 15/118,883

(22) PCT Filed: Feb. 17, 2015
(86) PCT No.: PCT/IB2015/051178

§ 371 Date: Aug. 15, 2016

(30) Foreign Application Priority Data
Feb. 18, 2014 (IN) 478/DEL/2014

(51) Int. Cl. A47J 37/08

(52) U.S. Cl. CPC A47J 37/0871; A47J 37/0814

(57) ABSTRACT

The various embodiments of the present invention disclose a toaster attachment comprising a top frame, at-least four vertical slots, a pair of horizontal strips and a stopper element. The top frame comprises a primary pair of strips and a secondary pair of strips. The secondary pair of strips is orthogonally attached to the primary pair of strips. The at-least four vertical slots are attached to the primary pair of strips forming a mesh arrangement. The pair of horizontal strips are attached to two adjacent vertical strips and are parallel to each other. The stopper element is attached to the pair of horizontal strips for preventing a movement of the horizontal pairs out of the vertical slots.

### BACKGROUND

### Technical Field of Invention

The embodiments herein generally relate to the field of consumer electronic goods and particularly relates to the hardware used in kitchen articles. The embodiments herein more particularly relate to a toaster and its attachment with improved heating and shut-off mechanism.

### DESCRIPTION OF RELATED ART

Electric toasters have been commonly employed for numerous years. Such toasters include a housing which defines one or more slots to receive the slice of bread, pastry or other item to be toasted. Located within the slot is a vertically moveable carriage upon which the bread rests, and a plurality of electrical heating elements which cause the toasting of the bread. In use, the carriage is moved downward to cause the bread to be received with the slots adjacent the heating elements, with the carriage being spring biased upward. At its lowest operative position, the carriage will be releasable locked into position with the physical presence of the carriage causing activation of a switch to energize the heating elements. After a predetermined time and/or temperature the carriage is released from this lowest position, with the spring bias tending to move the carriage upward. This upward movement will disengage the switch to de-energize the heating elements and bring the bread partially out of the slot where it may be manually retrieved by the user.

However, the prior arts have a drawback that the bread occasionally jams in the lowest position of the carriage when overheated. Further a popping up function of the bread in the prior arts proves inefficient due to a spring biasing force. In such instances, the carriage cannot move upward upon completion of the predetermined time and/or temperature.

In the view of foregoing, there is a need for an easy cleaning toaster with suitable attachment detachable in nature. Further, there is a need for a toaster with attachment to provide adequate heating and bread removal enhancement.

The above mentioned shortcomings, disadvantages and problems are addressed herein, as detailed below.

### OBJECTS OF THE INVENTION

The primary object of an embodiment herein is to provide a toaster attachment for easy cleaning with improved safety.

Another object of the present invention is to provide a toaster with an improved shut-off system.

A further object of the present invention is to provide a toaster with adequate heating and bread removal mechanism to avoid an overheating of the bread.

These and other objects and advantages of the embodiments herein will become readily apparent from the following detailed description taken in conjunction with the accompanying drawings.

### SUMMARY OF THE INVENTION

The various embodiments of the present invention disclose a toaster attachment comprising a top frame, at-least four vertical slots, a pair of horizontal strips and a stopper element. The top frame comprises a primary pair of strips and a secondary pair of strips. The secondary pair of strips is orthogonally attached to the primary pair of strips. The at-least four vertical slots are attached to the primary pair of strips forming a mesh arrangement. The pair of horizontal strips are attached to two adjacent vertical strips and are parallel to each other. The stopper element is attached to the pair of horizontal strips for preventing a movement of the horizontal pairs out of the vertical slots.

According to an embodiment herein, the primary pair of strips are further attached to a pair of net arranged parallel to each other and to the at-least four vertical strips. The pair of nets are attached orthogonally to the pair of primary strips.

According to an embodiment herein, the secondary pair of strips is slidable as well as rotatable in nature.

According to an embodiment herein, the toaster attachment further comprises a cuboidal cage made of wires, wherein the pair of horizontal wires are provided on two opposite pair of sides of the cuboidal cage, wherein the pair of horizontal wires has a vertical degree of movement.

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the spirit thereof, and the embodiments herein include all such modifications.

### BRIEF DESCRIPTION OF THE DRAWINGS

The other objects, features and advantages will occur to those skilled in the art from the following description of the preferred embodiment and the accompanying drawings in which:

FIG. 1-6 illustrates various assembly designs of a detachable attachment/coupling of the toaster, according to one embodiment herein.

### DETAILED DESCRIPTION OF THE DRAWINGS

In the following detailed description, a reference is made to the accompanying drawings that form a part hereof, and in which the specific embodiments that may be practiced is shown by way of illustration. The embodiments are described in sufficient detail to enable those skilled in the art to practice the embodiments and it is to be understood that the logical, mechanical and other changes may be made without departing from the scope of the embodiments. The following detailed description is therefore not to be taken in a limiting sense.

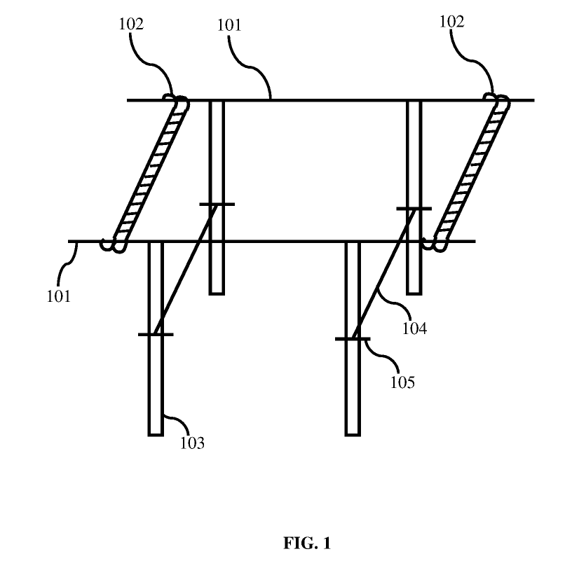

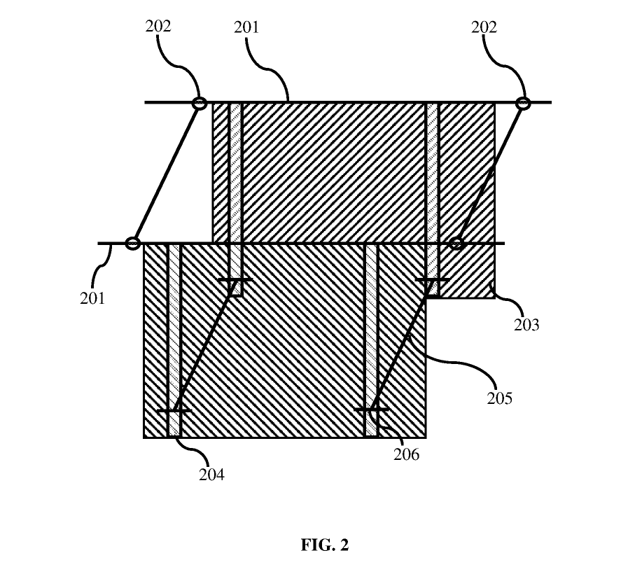

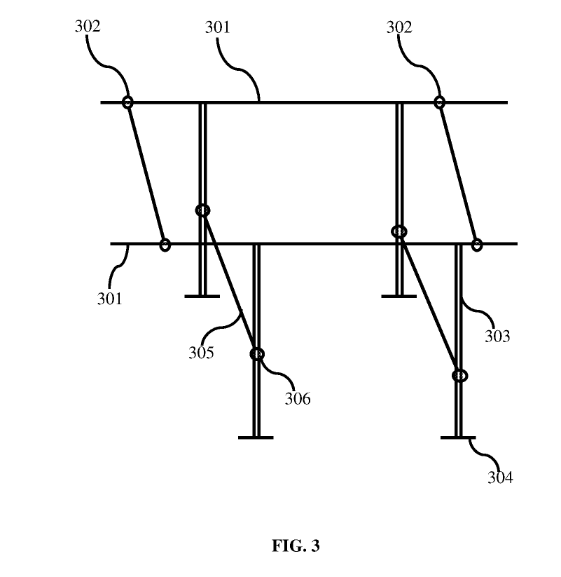

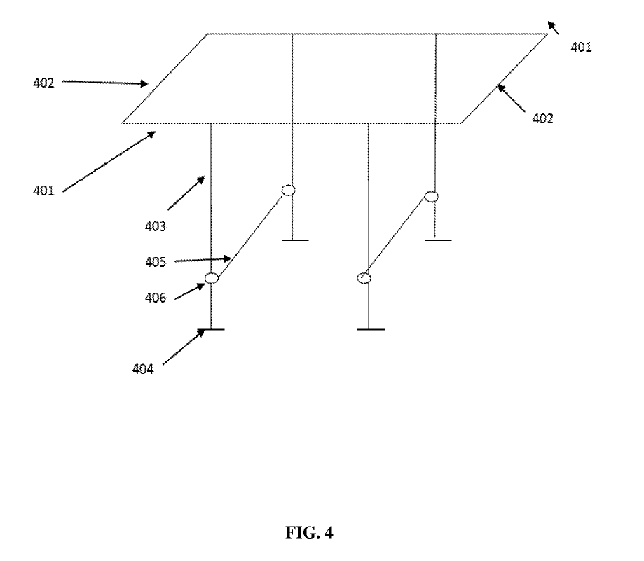

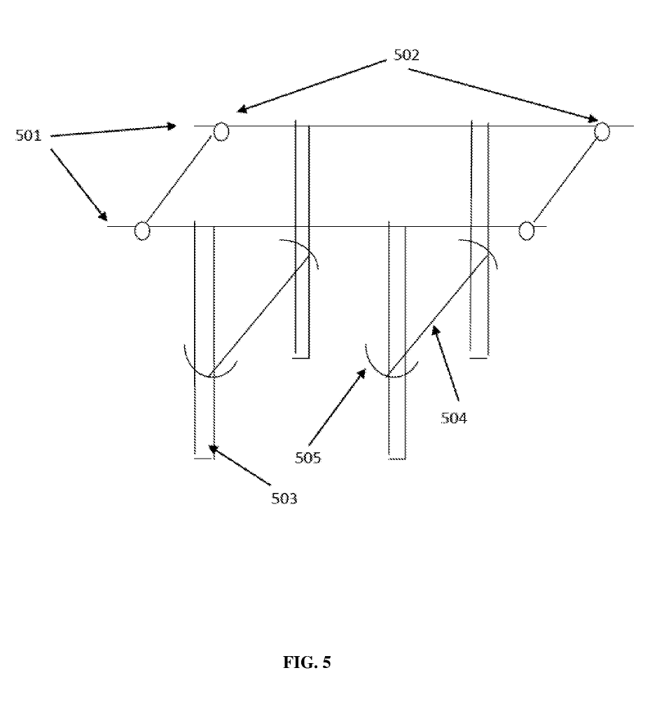

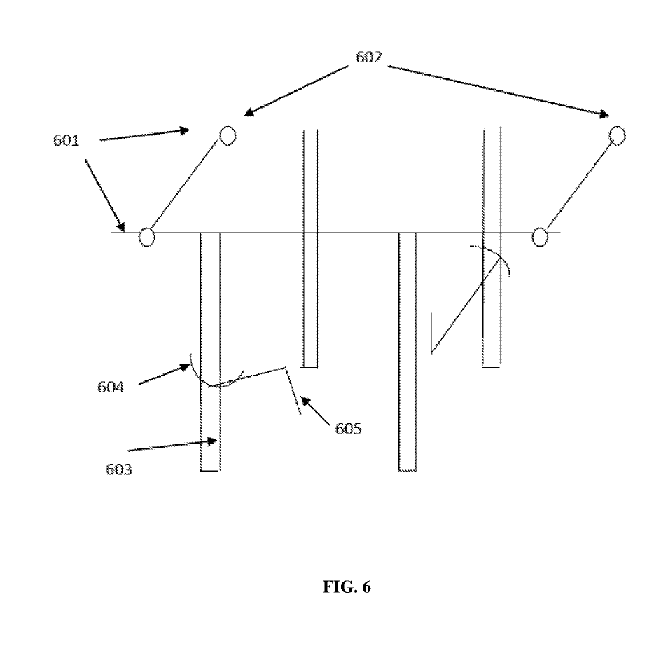

FIG. 1-6 illustrates various assembly designs of a detachable attachment/coupling of the toaster, according to one embodiment herein. With respect to FIG. 1, a toaster attachment comprising a top frame, at-least four vertical slots 103, a pair of horizontal strips 104 and a stopper element 105. The top frame comprises a primary pair of strips 101 and a secondary pair of strips 102. The secondary pair of strips 101 is orthogonally attached to the primary pair of strips 101. The at-least four vertical slots 103 are attached to the primary pair of strips 101 forming a mesh arrangement. The pair of horizontal strips 104 are attached to two adjacent vertical slots 103 and are parallel to each other. The stopper element 105 is attached to the pair of horizontal strips 104 for preventing a movement of the horizontal pairs out of the vertical slots 103. While the parts 104, 204, 304, 404, 504 and 604 are same, the design of the secondary pair of stripes changes denoted by the 102, 202, 302, 402, 502 and 602. The secondary pair of stripes 102 is rotatable in nature, slidable in nature (represented as 202, 302, 502 and 602) and fixed in nature (as represented in FIG. 4 as 402). The vertical slots or grooves are modifiable to a net or mesh design also as shown in FIG. 2 as 203. The stopper element (105, 206, 304 and 404) allows the pair of horizontal stripes to move vertically through vertical slots. Further in FIGS. 3, 4, 5 and 6, a pair of connectors (306, 406, 505 and 604) are provided to smoothen a movement of the pair of horizontal stripes during a vertical movement.

The said toaster attachment enables a user to easily withdraw a bread even if the spring of the toaster is not working properly. Also the toaster attachment prevent an over roasting or sticking of bread in the toaster.

It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the claims presented in the complete specification or non-provisional application.

I claim:

1. A toaster attachment comprising;
a top frame, wherein the top frame comprises:
a primary pair of strips;
a secondary pair of strips, wherein the secondary pair of strips is orthogonally attached to the primary pair of strips;
at-least four vertical slots, wherein the at-least four one vertical slots are attached to the primary pair of strips forming a mesh arrangement;
a pair of horizontal strips, wherein the pair of horizontal strips are attached to two adjacent vertical strips and are parallel to each other;
a stopper element, wherein the stopper element is attached to the pair of horizontal strips for preventing a movement of the horizontal pairs out of the vertical slots.

2. The toaster attachment according to claim 1, wherein the pair of primary strips are further attached to a pair of net arranged parallel to each other and to the at-least four vertical strips, wherein the pair of nets are attached orthogonally to the pair of primary strips.

3. The toaster attachment according to claim 2, wherein the pair of secondary strips is slidable as well as rotatable in nature.

4. The toaster attachment according to claim 1, further comprises a cuboidal cage made of wires, wherein the pair of horizontal wires are provided on two opposite pair of sides of the cuboidal cage, wherein the pair of horizontal wires has a vertical degree of movement.
